(19) United States
(12) Patent Application Publication
(10) Pub. No.: US 2026/0296846 A1
(43) Pub. Date: Oct. 1, 2026

(54) SUPPORT STRUCTURE FOR CRANE, CRANE COMPRISING SAID SUPPORT STRUCTURE, VESSEL COMPRISING SUCH CRANE

(71) Applicant: GustoMSC B.V., Schiedam (NL)

(72) Inventors: Wilhelmus Coenradus Johannes Jozephus WOLDRING, Rotterdam (NL); Mark Cornelius Marinus Franciscus ROMMENS, Maassluis (NL)

(21) Appl. No.: 18/880,309

(22) PCT Filed: Jul. 7, 2023
(86) PCT No.: PCT/NL2023/050369

§ 371 Date: Dec. 31, 2024

(30) Foreign Application Priority Data
Jul. 7, 2022 (NL) 2032417

(51) Int. Cl. B66C 23/52; B66C 23/82; B66C 23/84; F16M 11/08

(52) U.S. Cl. CPC B66C 23/52; B66C 23/82; B66C 23/84; F16M 11/08

(57) ABSTRACT

Support structure for a crane, the support structure comprising: a lower end having a circular shape for connection with a slewing bearing; an upper end having a polygonal shape for supporting a boom of the crane and/or a support frame of the crane; an outer side connecting an outer edge of the upper end with an outer edge of the lower end; wherein the upper end is provided with a pair of boom hinge connections for hingedly connecting the boom of the crane, and at least with a support frame connection for supporting the support frame of the crane; wherein the outer side at least partly comprises plate parts forming a wall section for transition from the polygonal shape of the upper end to the circular shape of the lower end, wherein the plate parts comprise flat plate parts and curved plate parts.

The invention relates to a support structure for a crane, in particular for an offshore crane.

Offshore cranes are widely known, and are typically mounted on a floating structure, such as a vessel or a barge or a jack-up. Offshore cranes can be used for various purposes, for example for heavy lifting operations at an offshore location such as installation and decommissioning of heavy structures like wind turbines, wind turbine foundations, platforms, top sides of platforms, etc.

An offshore crane typically comprises a boom pivotally mounted to a support structure. At a boom tip, a load can be hoisted. The support structure is rotatable mounted onto a base structure. The base structure is connected to the floating structure. Between the base structure and the support structure, a bearing is provided to allow for the rotating movement, also known as slewing movement, of the support structure with respect to the base structure. The bearing is often referred to as a slewing bearing accommodating the slewing movement of the support structure with respect to the base structure. The support structure is also known as a slewing platform, supporting at least the crane boom. The support structure further may support an A-frame or other support frame to which a hoisting and/or luffing system can be provided. In a so-called pedestal crane, the base structure may be referred to as a pedestal, and is fixedly mounted to the floating structure.

Via the support structure, the slewing bearing and the base structure, crane loads are transferred to the floating structure. Offshore cranes are becoming larger and heavier, as well as the loads that are being lifted and handled by these offshore cranes. To guide these loads towards the floating structure, via the support structure, the bearing and the base structure, these structures are becoming larger and, thus, heavier as well. This has a detrimental impact on e.g. vessel weight or vessel pay load. A slewing bearing of a diameter of more than 15 meters, or up to 30 meters is envisaged. Also, cranes with a lifting capacity between about 1000 metric tonnes (106 kg) and 10000 metric tonnes (107 kg) are known.

To accommodate such large cranes and such heavy lifting loads, there is a need to transfer these loads to the base structure and to the floating structure in an efficient manner.

An aim of the invention is to provide for a support structure that more efficiently, preferably also more effectively transfers crane loads to the base structure.

Thereto, the invention provides for a support structure for a crane, the support structure comprising a lower end having a circular shape for connection with a slewing bearing, an upper end having a polygonal shape for supporting a boom of the crane and/or a support frame of the crane, an outer side connecting an outer edge of the upper end with an outer edge of the lower end, wherein the upper end is provided with a pair of boom hinge connections for hingedly connecting the boom of the crane, and at least with a support frame connection for supporting the support frame of the crane. The outer side at least partly comprises plate parts forming a wall section for transition from the polygonal shape of the upper end to the circular shape of the lower end, wherein the plate parts comprise flat plate parts and curved plate parts. The curved plate parts may comprise single curved plate parts and/or double curved plate parts.

The support structure has a lower end with a circular shape such that is corresponds with the shape of the bearing to which it is to be connected. As such, the loads coming from the support structure can be transferred directly to the bearing. Also, the support structure has an upper end with a polygonal shape. The upper end typically is the side on which the boom, the support frame, and/or other equipment may be mounted. Boom hinge connections and at least one support frame connection are mounted to the upper end, directly or indirectly. Usually, a boom hinge connection may be provided by padeye-structures allowing hinge movement of the boom around a horizontal axis. The support frame connection may be a fixed structure, or may be hinge connections as well, e.g. when the support frame needs to be foldable. By providing a polygonal shape, e.g. rectangular, hexagonal, septagonal or octagonal, the connections of the boom and the support frame can be positioned in an optimal manner for taking up the large loads of the boom and support frame. By connecting the upper end with the lower end at least partly with plate parts, an efficient load transfer can be obtained from the polygonal upper end to the circular lower end, thus directing the loads optimally towards the bearing. As such, stress peaks or stress knots may be reduced.

It shall be appreciated that, as used herein, the term connection, such as in boom hinge connection and support frame connection, may be understood as a connecting structure or connector, i.e. being arranged and configured to connect with another structure, e.g. a boom or a support frame.

Further, it shall be appreciated that a polygonal shape as used herein merely indicates that a shape corresponds to a polygon in an overall or general sense, and thus this term does not necessarily imply that the shape has any sharp corners or is completely free from any curvature. For example, a polygonal shape as used herein may have at one or more of its vertices a so-called rounded-off corner where a pure polygon would have a sharp corner. Also, it shall be appreciated that polygons can take many different forms, including regular and irregular polygons, and may e.g. have one or more concave sections. A polygon generally has a limited number of sides joined at vertices, and in the present context the polygonal shape may correspond to a polygon having at most 16 such sides, preferably at most twelve such sides, more preferably at most ten such sides, for example about five, six, seven or eight such sides.

An outer side is connecting the upper end with the lower end, in particular is connecting an edge of the upper end with an edge of the lower end, and as such, the outer side provides for a transition from the polygonal shape of the upper end to the circular shape of the lower end. As such a smooth transition and load path can be provided from the polygonal upper end to the circular lower end, and, to the circular slewing bearing, in use, connected to the lower end. The outer side may thus have a rather complex geometrical shape providing for the transition from a circular lower end to a polygonal upper end. Often, the diameter of the circular end may be smaller than a largest diagonal dimension of the polygonal shape, requiring the outer side to flare out in upward direction. Contrary to conventional support structures, consisting of a cylindrical part with additional structures thereon, e.g. a rectangular platform or beam structures, the outer side of the support structure of the invention is of a more complex shape making the transition from circular to polygonal in a smooth and/or continuous manner without discrete or abrupt steps in the outer side.

The outer side can be at least partly provided with the plate parts, optionally allowing a portion of the outer side not being closed with plate parts, but remaining open. In the closed portion a wall section is formed connecting the lower end with the upper end. In the optional open portion, a truss structure can be provided to connect the upper end with the lower end. The truss members of such a truss structure can be cylindrically shaped truss members, or e.g. rectangular shaped truss members. Alternatively, a truss member may be a beam member.

The plate parts at least partly forming the outer side comprise flat plate parts and curved plate parts, wherein the curved plate parts may comprise single curved plate parts and/or double curved plate parts. Advantageously, the flat plate parts and the curved plate parts are arranged adjacent to each other. For example, they can be arranged in a sideways manner adjacent, such that, along a circumference of the outer side, a flat plate part alternates with a curved plate part. Alternatively, they can be arranged in a vertical manner adjacent, such that, in an upward direction, the curved plate parts are below the flat plate parts. As such, a smooth transition can be obtained between the circular shaped lower end and the polygonal shaped upper end, without abrupt or stepped transitions between the lower and the upper end.

Advantageously, the portion of the outer side that is closed with the plate parts comprises alternatingly flat plate parts and curved plate parts. For example, the plate parts may be substantially triangular shaped plate parts, subsequent plate parts may have their point of the triangle at the lower end and at the upper end. As such, the triangular shaped plate parts may alternatingly point upwards and downwards. Of course, it is understood that flat plate parts and curved plate parts may alternatively be arranged in a different manner. For example, the plate parts pointing downwards may be flat plate parts, the plate parts pointing upwards may be curved plate parts. Instead of or in addition to triangular shaped plate parts, trapezoid and/or kite shaped plate parts could be used. Some or all of the curved plate parts may be curved in two dimensions, so-called double-curved plate parts or double arcuate plate parts. Meanwhile, also single curved plate parts may be used. The flat plate parts extend substantially in a plane. The flat plate parts are straight, or planar plate parts, i.e. they are not curved. By alternating flat plate parts with curved plate parts, manufacturing costs may be kept limited, while accommodating the transition from the circular shaped lower end to the polygonal shaped upper end.

Advantageously, the entire outer side may be closed with plate parts thus forming a single wall section resulting in a closed wall. For example, at the vertices or corners of the polygonal shape, flat plate parts and curved plate parts may alternate, but in between the corners e.g. more flat plate parts may be used, or larger flat plate parts. It is understood that not all plate parts, flat or curved, need to be the same. By providing an entirely closed outer side, the plate parts can be load bearing and allow force transmission from the upper end to the lower end, and thus towards the bearing. In an alternative manner, not the entire outer side is closed, but, in particular a part of the outer side, in between corners of the polygon, can remain open. There, a truss structure can be provided for load transmission between the upper end and the lower end. Advantageously, at the corners of the polygon, plate parts are provided for the transition from polygonal shape to circular shape and for load transmission. By providing plate parts, in particular at the corners of the polygon shape, where forces may be expected higher, plate parts may provide for efficient and effective load transmission of loads towards the circular shaped lower end. Additionally, parts of the plate parts themselves may vary in thickness, to allow for the most efficient load path.

Advantageously, the connections of the boom of the crane and/or the at least one connection of the support frame of the crane are provided at the vertices or corners of the polygonal shape. As such, the connections may define the shape of the polygon. It may be understood that a pair of boom hinge connections can be integrated to a pair of support frame connections, e.g. in a single pair of padeyes. Also, it can be understood that e.g. a pair of boom hinge connections can be mounted at corners of the upper end, and that the support frame connections may be mounted more inwardly or vice versa. This provides for an efficient structure, as at the position where the loads occur, the load is directly transferred into the support structure, preferably even in a direction towards the circular shaped lower end corresponding to the slewing bearing. As such, the transmittal of forces from the position entering the support structure towards the slewing bearing, can be done efficiently. This allows the forces to be transmitted to the slewing bearing in an effective manner, effectively limiting-peak-loads onto the slewing bearing. This may allow a more efficient and/or more compact design of the slewing bearing.

Alternatively, the flat plate parts can be arranged above the single and/or double curved plate parts. Thus, a lower wall section of the outer side can be conically shaped, while an upper wall section of the outer side can be polygonal shaped. An intersection line between the lower section and the upper section then comprises arc lines. This is contrary to the conventional support structures having a cylindrical lower section and superposed thereon a rectangular upper section, with abrupt and discrete transition between the cylindrical and the rectangular section. According to the invention, the upper section is merely merged to the lower section resulting in the arc lines of the intersection line. By providing the conical shaped lower wall section with a mere joined, instead of superposed, polygonal shaped upper wall section, such that arc lines form the intersection line, a smooth transition from the circular shaped lower end to the polygonal shaped upper end is possible. Such smooth transition provides for a more effective load transfer from the boom hinge connections and/or the support frame connections to the slewing bearing with less stress knots or stress spikes.

Advantageously, below each connection of the boom or of the support frame to the support structure, a box structure is provided to enable load transmission from the associated connection to the outer side and/or the lower end of the support structure. In fact, underneath each connection, a boom hinge connection and/or a support frame connection, a box structure is provided. This box structure supports the respective connection and provides for load introduction from the connection to the support structure, in particular to the outer side of the support structure, and eventually to the lower end of the support structure. It shall be appreciated that such box structures may be mutually joined and/or integrated, as explained further elsewhere herein. In other words, such box structures need not be mutually spaced apart or otherwise structurally separate or distinct. A top side of the box structure may provide for a deck area at the upper end of the support structure. The boom hinge connections and/or the support frame connections may be mounted to a top side of the box structure. The box structure may also be joined to the outer side of the support structure, at an inside thereof. As such, the box structure underneath each of the connections, may form a vertex or corner of the polygon at the upper end of the support structure. Advantageously, the box structure is joined to the outer side, thus reinforcing the outer side and providing an efficient load path towards the outer side.

A box structure height of the box structure may be larger at the boom hinge connections compared to at support frame connections spaced apart from the boom hinge connections. Thereby, more load transfer capacity and/or higher stiffness may be provided in areas where loads from the boom are primarily transmitted, while otherwise weight and material may be saved.

Advantageously, at least two of the box structures underneath of their associated connections can be joined to each other, thus forming an elongated box structure supporting at least two connections. Such an elongated box structure may thus form a side of the polygonal shape extending e.g. between two adjacent vertices or corners of the polygonal shape. This provides for a stiff structure, as well as may provide for some deck area at the upper end of the support structure between the connections as well. Advantageously, all the box structures are joined to each other forming a box frame defining an outer edge of the polygon. The thus joined box structures provide for a polygonal overall box structure defining the polygonal shape of the upper end of the support structure and supporting the connections forming a peripheral box structure. This provides for some deck area at the outer edge of the upper end, while allowing a center of the upper end inside of the polygonal shape open, e.g. to receive equipment or a leg of a jack-up. Also, the joined box structures defining such a box frame, result in a relatively stiff and strong frame at the outer edge of the upper end allowing efficient load transfer into the support structure. In an example, there may be a pair of hinge boom connections and a first pair of support frame connections. The hinge boom connections may be integrated to a second pair of support frame connections, thus a polygon with four corners may be obtained, a quadrangle. Such integration may take various forms, e.g. by sharing same padeyes and/or same shafts connecting to such padeyes. Each connection is supported by a box structure. The box structures may be joined to each other thus forming a box frame along an outer edge of the quadrangle. This quadrangular box frame may provide for a strong and stiff frame supporting the connections and providing for effective load transfer to the support structure. In another example, there may be a pair of boom hinge connections, and two pairs of a support frame connections, thus providing six corners, resulting in a hexagonal shaped upper end. When adjacent box structures underneath the associated connections are joined to each other, a hexagonal box frame is obtained, providing for a stiff and strong edge of the upper end of the support structure Although in these examples all vertices or corners of the polygon are associated with at least one connection, it shall be appreciated that one or more additional vertices or corners may be provided being free from such a connection, for example so as to enable a smoother overall transition towards the circular shape.

In an example, below a box structure a pyramidal shaped structure may be provided to further facilitate load transfer to the outer side, and, further to the lower end. Instead, such pyramidal structure can be integrated to the box structure as well.

An inside of the outer side of the support structure may further be provided with at least one circumferential ring structure. Such circumferential ring structure advantageously is approximately parallel to the lower end, and/or the upper end, of the support structure, and goes around along the circumference of the outer side. Such ring structure provides for additional stiffness, and strength. Alternatively, such ring structure can be provided at an outside of the outer side. However, providing the ring structure at an inside, may be advantageous as this may additionally give some shielding from environmental influences, which may increase life time.

Further, the outer side of the support structure may be provided with upwardly extending stiffeners, at an inside of the outer side or at an outside of the outer side. The stiffeners may pass the circumferential ring via openings in the ring structure.

The invention further relates to a crane comprising such support structure, as well as to a vessel provided with such a crane.

Further advantageous embodiments are provided by the features of the subclaims.

These and other aspects will further be elucidated with reference to the drawing comprising figures of exemplary embodiments. In the drawing shows:

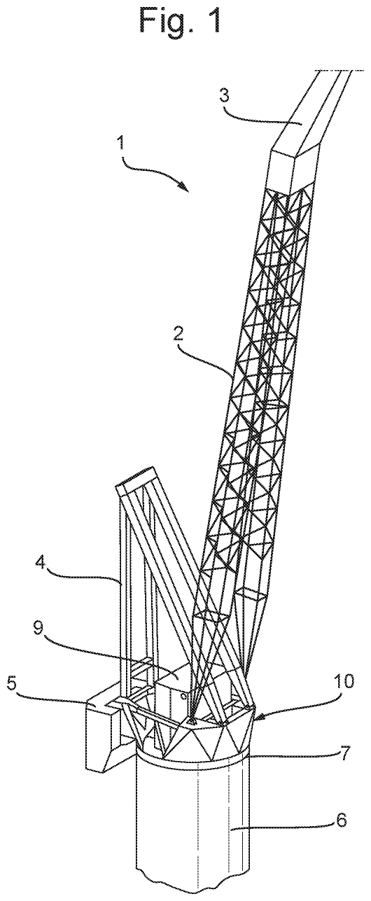

FIG. 1 a general arrangement of a crane, in particular a pedestal crane for mounting on an offshore structure;

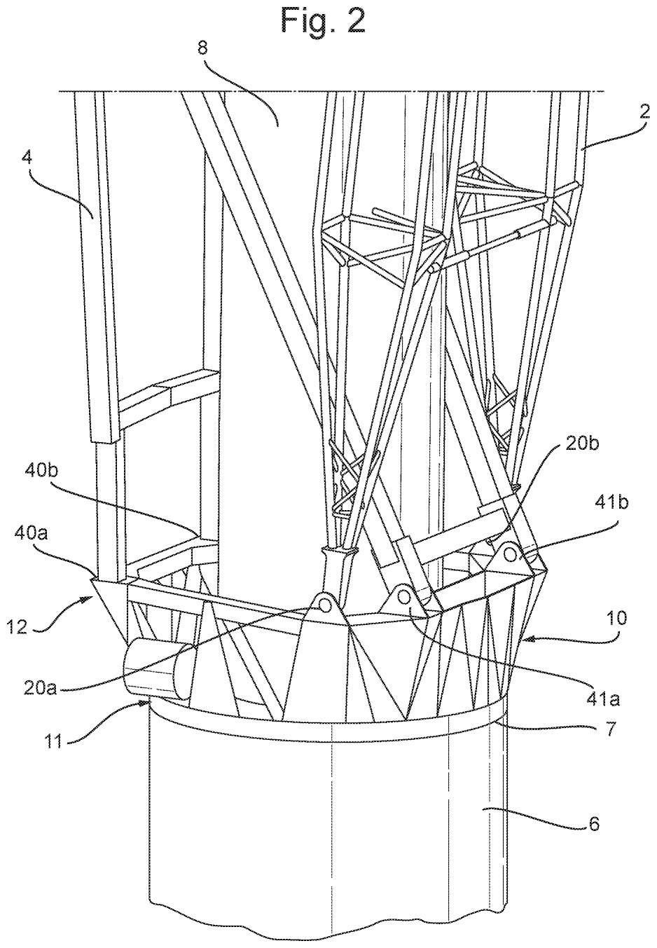

FIG. 2 a general arrangement of a crane, in particular a leg crane, for mounting around a leg of an offshore structure;

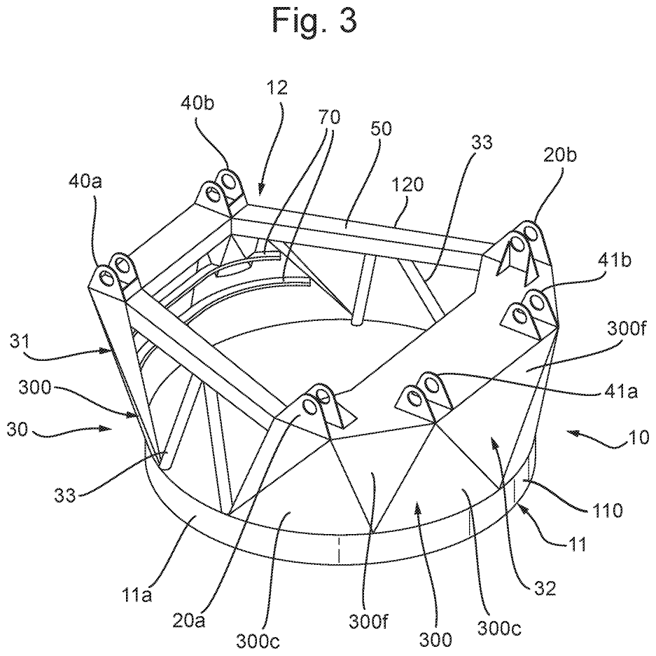

FIG. 3 a first embodiment of a support structure according to the invention;

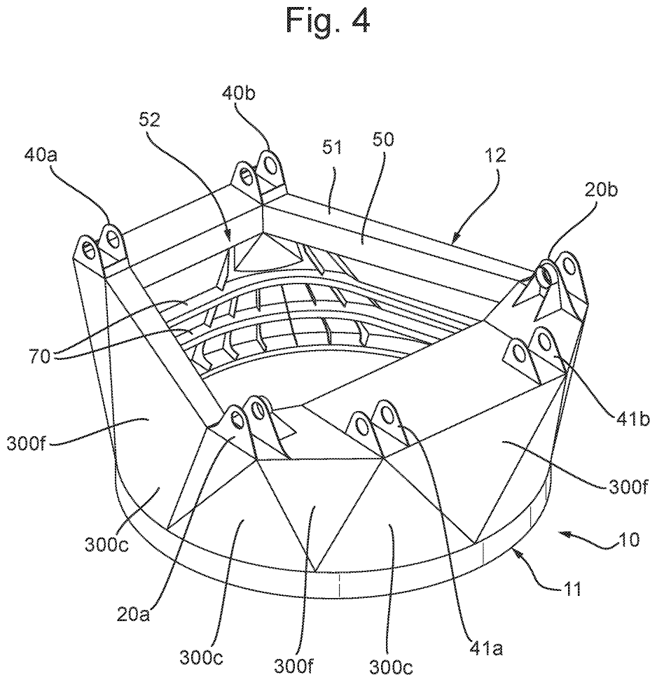

FIG. 4 a second embodiment of a support structure according to the invention;

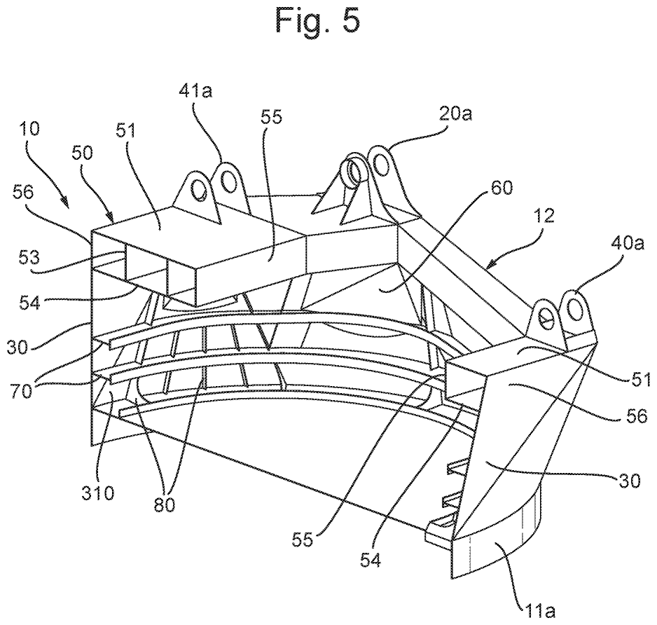

FIG. 5 a cross-section of the embodiment of FIG. 4;

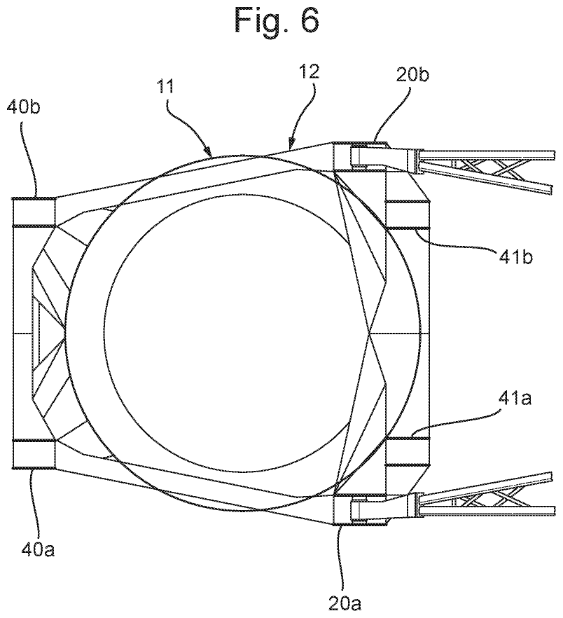

FIG. 6 a top view of a support structure according to the invention;

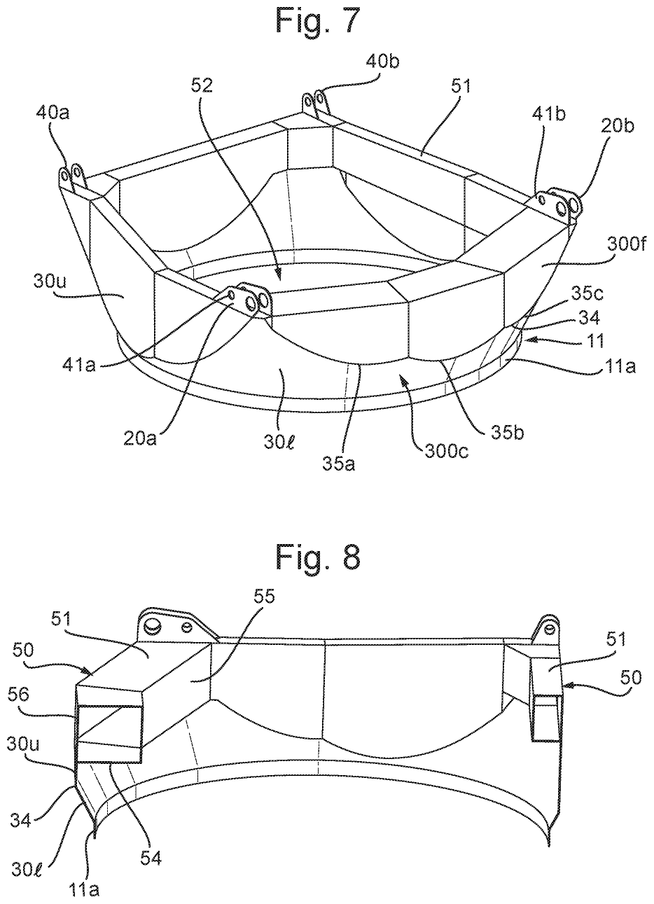

FIG. 7 a third embodiment of a support structure according to the invention;

FIG. 8 a cross-section of an embodiment according to FIG. 7;

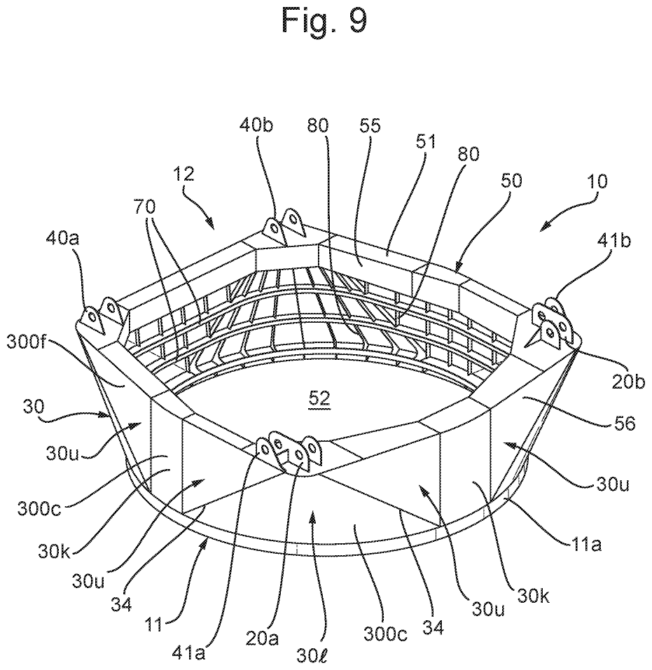

FIG. 9 a fourth embodiment of a support structure according to the invention;

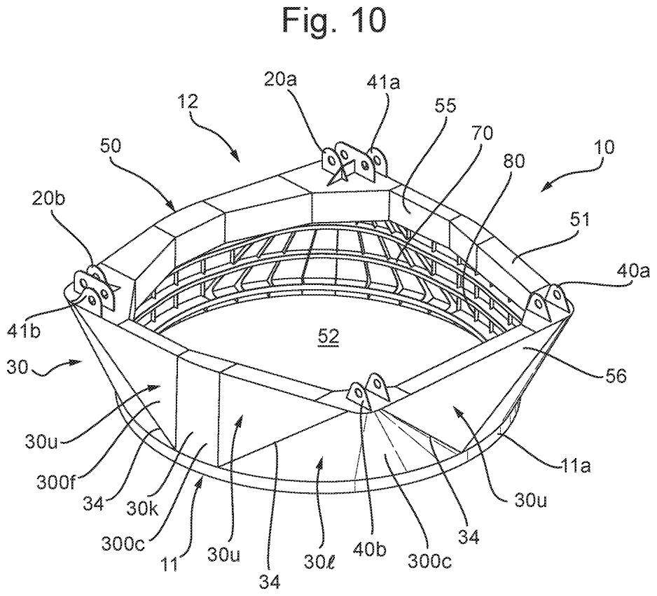

FIG. 10 the embodiment of FIG. 9, viewed from an opposite side compared to FIG. 9;

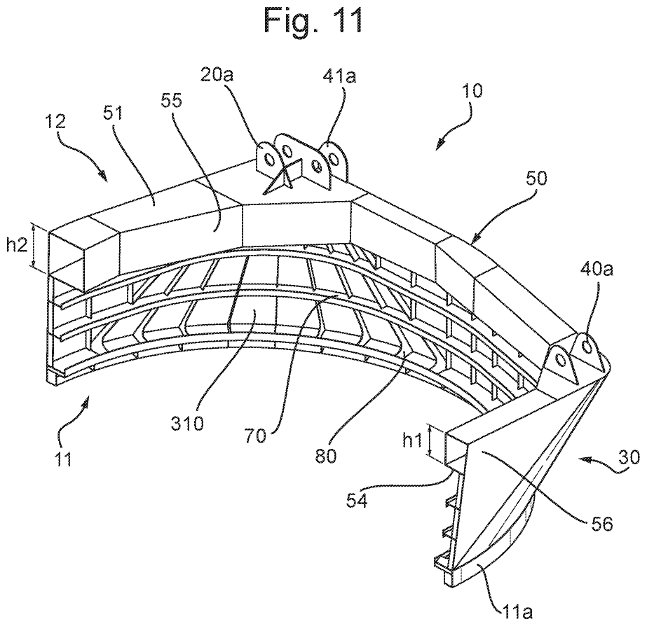

FIG. 11 a vertical cross section of the fourth embodiment as viewed in FIG. 10;

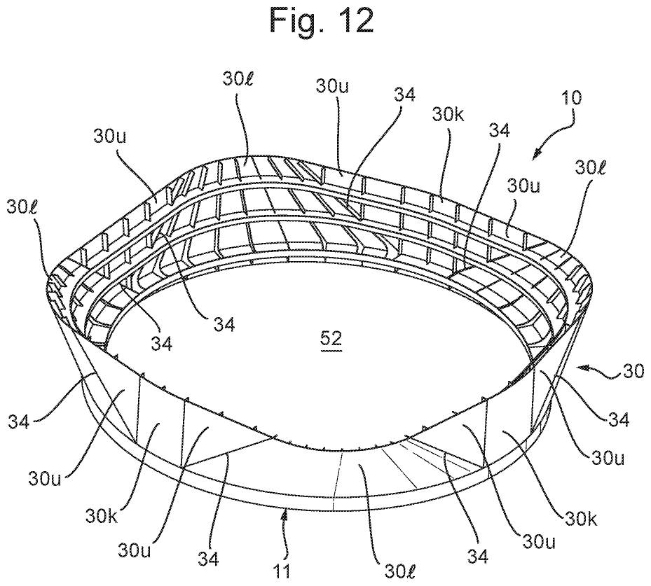

FIG. 12 a horizontal cross section of the fourth embodiment as viewed in FIG. 9;

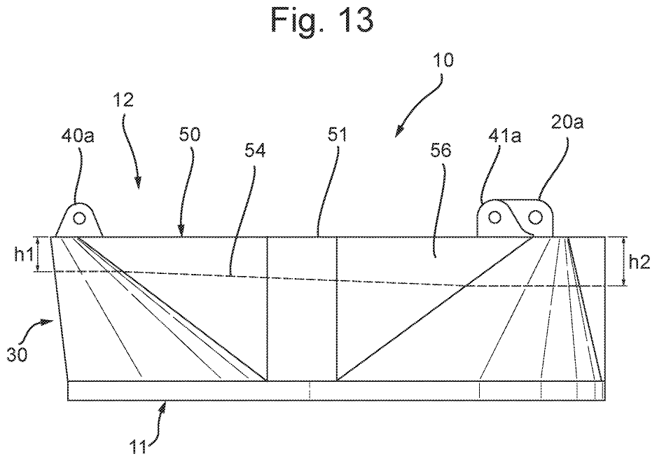

FIG. 13 a side view of the fourth embodiment; and

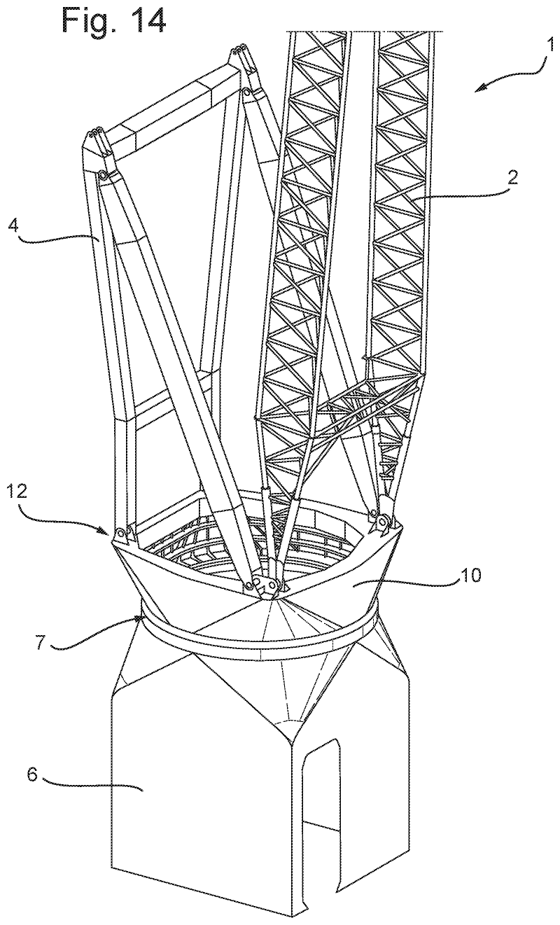

FIG. 14 an offshore crane comprising the support structure according to the fourth embodiment.

It is to be noted that the figures are given by way of exemplary examples and are not limiting to the disclosure. The drawings may not be to scale. Corresponding elements are designated with corresponding reference signs.

FIG. 1 shows a general arrangement of an offshore crane 1. The crane 1 comprises a boom 2 with a boom tip 3 for hoisting a load. The crane 1 further comprises a support frame 4, here embodied as an A-frame. The support frame 4 is arranged for supporting hoisting and/or luffing wires for lifting the boom 2 and/or hoisting the load. For reasons of simplicity, the hoisting system and the luffing system are not shown. A drive system for driving the hoisting system and/or the luffing system can be provided in a winch house 5, that e.g. can enclose winches to drive said systems. The support frame 4 and the boom 2 are mounted onto a support structure 10.

The support structure 10 is rotatable mounted onto a base structure 6. The base structure 6 is mounted to the offshore structure, e.g. to a deck of a vessel or jack-up. The base structure 6 is also known as pedestal. Between the base structure 6 and the support structure 10, a slewing bearing 7 is arranged allowing rotational movement of the support structure 10 with respect to the base structure 6 around a vertical axis. The support frame 4 here has four legs, each mounted to the support structure 10 via support frame connections. The support frame connections are mounted to the support structure 10. It may be understood that other support frame configuration may comprise three legs with three support frame connections. The boom 2 here has two boom legs mounted to the support frame via boom hinge connections. The boom is hingedly arranged to the boom hinge connections and can rotate around a horizontal rotation axis through the boom hinge connections. Here, in the support structure 10, an equipment box 9 is shown. Alternatively, the support structure 10 can be closed or the equipment can be mounted elsewhere on the offshore structure.

FIG. 2 shows an alternative arrangement of an offshore crane 1. In FIG. 2, the crane 1 is mounted around a leg 8 of the offshore structure, the so-called leg crane. Offshore structures, such as a jack-up, are provided with three or more legs that are adjustable in height with respect to a hull of the offshore structure. Around such leg, the offshore crane 1 can be mounted. The support frame 4, and the boom hinge connections are then arranged to allow the leg to be adjusted up and downward. Here too, the support frame 4 and the leg 2 are mounted to the support structure 10. The support structure 10 is mounted to the base structure 6 which may be mounted onto a deck of the offshore structure. Between the base structure 6 and the support structure 10 a slewing bearing is arranged to allow rotational movement of the support structure 10 with respect to the base structure around a vertical axis.

The support structure 10 has a lower end 11 arranged for mounting to the slewing bearing and an upper end 12 for supporting the support frame 4 and the boom 2 of the crane 1, as also shown in FIG. 3. The upper end 12 has a polygonal shape to accommodate the positions of the boom hinge connections 20a, 20b and of the support frame connections 40a, 40b, 41a, 41b. In the examples of FIG. 1 and FIG. 2, the support frame connections 41a, 41b and the boom hinge connections 20a 20b are separate connections. It is understood that they can be integrated as well. For example, the support frame connection 41a and the boom hinge connection 20a can be integrated into a single connection mounted to the support structure 10. Typically, such a connection can be embodied as a pad eye as e.g. shown in FIG. 3. The lower end of the support structure 10 has a circular shape corresponding to the shape and size of the slewing bearing. As such, the lower end 11 of the support structure 10 corresponds with the slewing bearing, and load transfer to the slewing bearing can be done in a more effective manner. The lower end 11 has a circular edge 11a comprising an inwardly and/or outwardly extending flange for mounting to the slewing bearing. The upper end 12 has a polygonal shape. Between the upper end and the lower end, an outer side 30 is provided connecting the circular shaped lower end 11 and the polygonal shaped upper end 12. In particular, the outer side 30 connects an outer edge 120 of the upper end 12 with an outer edge 110 of the lower end 11. The outer side 30 at least partly comprises plate parts 300 to form wall sections 31, 32 of the outer side 30 connecting the upper end 12 with the lower end 11 in a smooth and/or continuous manner. The plate parts 300 can be flat plate parts 300f and curved plate parts 300c. In the example of FIG. 3, only two parts of the outer side 30 are provided with plate parts, thus forming two wall sections 31, 32. In between the two wall sections 31, 32, the outer side 30 is open and a truss structure 33 is provided to connect to the lower end 11 with the upper end 12. Preferably, most of the curved plate parts are single curved plate parts, i.e. having a curvature in one dimension only. Meanwhile, at least some of the curved plate parts, in particular those at relatively sharp vertices or corners of the polygonal shape, may be double curved plate parts. By providing such curved plate parts, it becomes easier to accommodate the transition from circular shape at the lower end to polygonal shape at the upper end of the support structure. It shall be appreciated that curvatures of curved plate parts may vary and may generally be selected to contribute to a gradual transition from the circular shape to the polygonal shape.

Single curved plate parts are preferred where such a single curve suffices, since single curved plate parts are generally more economical than double curved plate parts.

In a wall section 31, 32, comprising the plate parts 300f, 300c, the flat plate parts 300f and the curved plate parts 300c are arranged adjacent each other in an alternating manner. A flat plate part 300f is adjacent to a curved plate part 300c that is adjacent a flat plate part 300f etc. when seen in circumferential direction. In a sideways manner, the flat plate parts 300f and the curved plate parts 300c are positioned side-by-side adjacent to each other. By providing alternatingly the flat plate parts 300f and the curved plate parts 300c, a wall section 31, 32 is formed that connects the circular shaped lower end 11 with the polygonal shaped upper end 12 in a smooth manner, obviating any discrete or abrupt transitions.

Advantageously, the plate parts 300 are substantially triangular shaped. Flat parts 300f can be oriented with their point of the triangular shape downwardly, while curved plate parts 300c can be oriented with the point of their substantially triangular shape upwardly. As such, the curved plate parts 300c can connect with the circular shaped lower end and extend upwardly. The flat plate parts can connect to the polygonal shaped upper end and extend downwardly. Adjacent flat plate part and curved plate parts are joined at their coinciding long side of the triangular shape, e.g. by welding.

In the example of FIG. 3, two wall sections 31, 32 are provided with an open space in which the truss structure 33 connects the upper end 11 and the lower end 12. Alternatively, the open space can be closed by plate parts, thus obtaining an entirely closed outer side 30, forming a single wall section, as shown in FIG. 4. Over the circumference of the outer side 30, the flat plate parts 300f and the curved plate parts 300c alternate with each other, forming a smooth transition from the circular shaped lower end 11 to the polygonal shaped upper end 12.

It can be seen that in vertices or corners of the polygonal shaped upper end, the curved plate parts 300c end, and in between the corners, flat plate parts 300f are advantageously provided. As such, optimal use is made of the flat plate parts and of the curved plate parts, to limit the use of curved plate parts, which are more expensive to manufacture than the flat plate parts.

Both in FIG. 3 and in FIG. 4, it can be seen that the boom hinge connections 20a, 20b, and the support frame connections 40a, 40b, 41a, 41b are separate connections mounted to the upper end 12. Here, a connection is provided at a corner of the polygon forming the upper end 12, thus obtaining a hexagon. In an example in which a pair of boom hinge connections 20a, 20b is integrated with a pair of support frame connections 41a, 41b, a quadrangular or septagonal shaped upper end can be obtained, with on each corner a connection mounted.

It can be seen that below each connection 40a, 40b, 41a, 41b, 20a, 20b a box structure is provided. The box structure provides support to the connections, and allows the forces to enter the outer side 30 and to be transmitted to the lower end, and further to the slewing bearing. In the embodiments of FIG. 3 and FIG. 4 the respective box structures of the associated connections 40a,40b, 41a, 41b, 20a, 20b are joined to each other forming a joined box structure 50 on which the connections are arranged. The joined box structure 50 forms a peripheral box frame of which a top side 51 provides for deck area. The peripheral box frame 50 forms an outer edge of the polygonal shaped upper end 12, thus defining the polygonal shape of the upper end 12 of the support structure. The peripheral box frame 50 allows an opening 52 in which e.g. equipment can be positioned, or in which the leg of a jack-up can be accommodated. By providing such peripheral box frame 50 additional strength and stiffness can be added to the support structure, which can be beneficial for load transmission. The box structure has a top side 51 forming a deck area of the support structure 10, and has a lower side 54 parallel to the top side 51, an inner side 55 and an outer side 56 provided by the outer side 30 of the support structure. As such, a box shape is obtained that optimally supports the associated connection.

In the cross-section of FIG. 5, the box configuration of the box structure 50 can be seen. A top side 51 of the box structure provides for deck area, an outer side 56 of the box structure 50 is joined with the outer side 30 for optimizing force transmission. Further, the box structure is a hollow box, which can have ribs 53 for stiffness and/or strength. Also, in the cross-section of FIG. 5, the circular edge 11a is shown that joins with the outer side 30. The edge 11a is mounted onto the slewing bearing.

In the cross-section of FIG. 5 it can be seen that below the box structure 50 underneath connection 20a, a further pyramidal structure 60 is provided. Such pyramidal structure 60 is optional, but can provide for additional strength and/or stiffness, as well as may further transfer the forces from the connection towards the lower end 11. In this sense, the further structure 60 may be regarded as an auxiliary load transfer structure. Although in this example this further structure 60 has a pyramidal shape, it shall be appreciated that different shapes are possible for such a structure.

As can be seen in the cross-section of FIG. 5, or in the perspective view of FIG. 3 or FIG. 4, an inside 310 of the outer side 30 is provided with a circumferential ring structure 70. The ring structure 70 is approximately horizontally arranged, or, said differently, approximately parallel with the lower end 11 of the support structure 10. The circumferential ring 70 preferably covers an entire circumference of the outer side 30, at an inside thereof. Although in FIG. 3 it can be seen that the ring structure 70 is intermittent between the wall sections 31, 32. However, also in the example of FIG. 3, with an open space between the wall sections 31, 32 it is preferred that the ring structures 70 are provided over the entire circumference of the outer side 30, thus may be connected to the truss structure 33 there. The at least one ring structure 70 provides for additional strength and stiffness to the support structure, in particular also rotational or torsional stiffness. Further, the outer side 30 may also be provided with at least partially upwardly oriented stiffeners 80, as can be seen in the cross-sectional view of FIG. 5. The stiffeners 80 go through openings in the ring structure 70 allowing the stiffeners to pass through. The stiffeners 80 may e.g. additionally reinforce the curved plate parts 300c. It is to be noted that the ring structure 70 and/or the stiffeners 80 also can be provided at an outside of the outer side 30. However, providing the ring structure 70 and/or the stiffeners 80 at an inside may provide the advantage of more shielding from environmental influences as well as more easy accessibility for maintenance and/or repair.

FIG. 6 shows a top view of the support structure 10 having a hexagonal shape with the boom hinge connections 20a, 20b and the support frame connections 40a, 40b, 41a, 41b on the respective vertices or corners of the hexagon. The circle identifying the circular shaped lower end 11 of the support structure 10 is also shown. It can be seen that the connections 40a, 40b, 41a, 41b, 20a, 20b are positioned outwardly of the circle of the lower end 11, so the forces are to be transferred to the lower end in a radial direction as well as in axial direction, or said differently, in a horizontal direction as well as in a vertical direction. The support structure 10 according to the invention, with the plate parts 300 providing for a smooth transition from the polygonal shaped upper end 12 to the circular shaped lower end 11, allows transfer of the forces to the slewing bearing in an effective and efficient manner, while reducing and/or minimizing stress peaks. By providing the support structure 10 according to the invention allowing an efficient and effective force transmission, less material can be used as opposed to conventional support structures. Less material may result in a lighter support structure, which aids in increasing the pay load for the offshore vessel, while accommodating such very large cranes.

FIG. 7 shows an alternative embodiment for the support structure 10. Here, the flat plate parts 300f and the curved plate parts 300c are positioned above each other in an adjacent manner. The flat plate parts 300f are positioned above the curved plate parts 300c. As such, the curved plate parts 300c may form a conical shaped lower wall section 30l flaring outwardly from the lower end 11. The flat plate parts 300f form a polygonal shaped upper wall section 30u extending downwardly from the upper end 12. Where the upper wall section 30u meets the lower wall section 30l, an intersection line 34 is formed at which the upper wall section 30u is joined with the lower wall section 30l. The intersection line 34 here comprises arc line portions 35a, 35b, etc. In other examples, see e.g. FIGS. 9 and 10, such an intersection line 34 may be straight. Contrary to the conventional support structures in which a rectangular upper part is superposed onto a cylindrical lower part, here, the upper wall section is merely merged to the lower wall section resulting in such an intersection line that is neither parallel nor perpendicular to the upper and lower ends.

Here too, below each connection 20a, 20b, 40a, 40b, 41a, 41b a box structure 50 is provided, which in this example are joined to a single joined box structure 50 forming a peripheral box frame 50 forming the upper end 12 of the support structure. Thus, as previously indicated, although each connection may be considered to be provided with a respective box structure, such box structures need in fact not be separate or distinct but may instead form part of a larger combined structure such as the peripheral box frame 50, wherein the various connections may in fact all be arranged on said same frame. Here, a pair of support frame connections 41, 41b is integrated to the boom hinge connections 20a, 20b in a single connection. The thus integrated connection is positioned at a corner of the polygonal shaped upper end 12. The other pair of support frame connections 40a, 40b is positioned at two other corners of the polygonal shaped upper end 12. In an example, the polygon may thus become a quadrangular. However, in the example shown in FIG. 7, between the integrated connections 41a, 20a. 41b, 20b a segmented side is arranged resulting in a polygonal shape with more than four vertices or corners, for example to fit around a jack-up leg. It is understood that the boom hinge connections and the support frame connections can be mounted separately to the support structure as well. A top side 51 of the support structure 50 gives a deck area. In the example of FIGS. 7 and 8, the support frame connections 40a, 40b are somewhat higher positioned than the connections 41a, 20a, 41b, 20b respectively such that the top side 51 is sloping upward from the connections 41a, 20a, 41b, 20b to the connections 40a, 40b respectively. Alternatively, all connections can be mounted on the same level. In the cross-section of FIG. 8, corresponding to the same example as FIG. 7, it can be seen that the box structure 50 has a box shape in a similar manner as in FIGS. 3, 4. Here the box structure 50 has a top side 51 forming a deck area, an inner side 55, a lower side 54, and an outer side 56 formed by the outer side 30. A circumferential ring structure 70 is not shown here, but can be provided for stiffness. The circular edge 11a extends downwardly and is configured for mounting to the slewing bearing. Further, as in the examples of FIG. 3 and FIG. 4, upwardly oriented stiffeners 80 can be provided. The peripheral box frame 50 defines the polygonal shape of the upper end 12, and allows a central opening 52 in which equipment or a jack-up leg can be accommodated. The lower end 11 can be closed with a bottom as shown in FIG. 3 or FIG. 4, or can be open as in FIG. 7 or FIG. 8.

FIGS. 9 to 14 show a particularly advantageous fourth embodiment of the support structure 10. Apart from where the figures and/or the present description indicate or imply otherwise, this fourth embodiment generally corresponds to other embodiments as disclosed herein, as may be understood in particular from the corresponding reference signs in the figures.

In the fourth embodiment, as best seen in FIG. 13 and also indicated in FIG. 11, a height of the box frame 50 varies between a smaller first height h1 at the support frame connections 40a, 40b and a larger height h2 at the support frame connections 41a, 41b and the boom hinge connections 20a, 20b. Thereby, a strength of the box frame 50 can be greater at the side of the boom 2, where larger loads may be expected, while otherwise weight can be minimized by reducing the box frame height elsewhere. Here, the variable height is essentially realized by a variable level of the lower side 54 (indicated by a dashed line 54 in FIG. 13) of the box frame 50, while the top side 51 of the box frame 50 is here horizontal, thus forming a level deck area. A gradual change of the box frame height between the first and second heights h1, h2 avoids areas of high stress and promotes gradual force distribution through the support structure 10.

In the fourth embodiment, the polygonal shape of the upper end 12 can be seen to be septagonal, i.e. having seven sides. It has been found that such a number of sides generally contributes to an advantageous load transfer efficiency between the discrete positions of the connections at the upper end 12 and the circular slewing bearing 7 at the lower end 11. Still, it shall be understood that the number of sides could also be somewhat different, e.g. six or eight, with substantially the same advantageous effect.

Further, compared to other embodiments disclosed herein, the outer side 30 is formed particularly smoothly in the fourth embodiment, corresponding to a particularly gradual transition between the polygonal shape of the upper end 12 and the circular shape of the lower end 11. This can be seen particularly well in FIG. 12, showing a horizontal cross section in which the box frame 50 is not shown. Thereby, efficient load distribution through the support structure 10 is further optimized, the efficiency in particular being with respect to a weight of the support structure 10. As part of the enhanced smoothness, the upper end 12 in this embodiment has rounded-off corners at the vertices of its polygonal shape, in particular at those vertices where the connections 20a, 20b, 40a, 40b, 41a, 41b are arranged. Specifically, the rounded-off corners at some or all of the vertices may be arc shaped. The level of rounding-off is such that the overall polygonal shape is maintained. At the rounded-off corners at the connections, curved plate parts 300c may be double curved to accommodate both the rounding-off and the flaring, while further away from said rounded-off corners the curved plate parts 300c may be single curved. Thus, in the fourth embodiment (FIGS. 9 to 14), the relatively complex three-dimensional shape of the outer side 30 may generally be realized by flat plate parts 300f and single curved plate parts 300c, apart from close to the vertices at connections 20a, 20b, 40a, 40b, 41a, 41b, where at each vertex one or some double curved plate parts may be needed.

Further, compared to the third embodiment, three full-height wall parts 30k are provided at positions circumferentially halfway along respective three of the upper wall parts 30u, which may thereby be considered as separated into two halves compared to the third embodiment. The full-height wall parts 30k here comprise curved plate parts 300c which in this case are single curved so as to essentially follow an arcuate curvature of the lower end 11 all the way up to the upper end 12. In FIGS. 9, 10 and 12, these full-height wall parts 30k have been provided with a checkerboard hatching on their outside merely to more clearly distinguish them from the neighboring halves of the upper wall parts 30u. The positions of the full-height wall parts 30k along the polygonal shape of the upper end 12 here correspond to three relatively blunt vertices, at least compared to the sharper four vertices where the connections are arranged. When viewed from above, these blunt vertices of the upper end 12 may coincide with the circular shape of the lower end 11, so that the full-height wall parts 30k need not flare like the lower wall parts 30l do. Moreover, the bluntness of these vertices means that they may be rounded off such that the arcuate curvature of the lower end 11 is thereby locally followed at the upper end 12, without losing the overall polygonal shape of the upper end.

FIG. 14 shows how the support structure 10 according to the fourth embodiment can be implemented in an offshore crane 1, with a boom 2 and a support frame 4 shown mounted to the support structure 10 via the connections at the upper end 12. It shall be appreciated that the boom 2 and the support frame 4 can each be of various designs and are thus only shown schematically here. A base structure 6 is seen positioned below the support structure 10, with a slewing bearing 7 providing rotatability of the support structure 10 with respect to the base structure 6.

For the purpose of clarity and a concise description, features are described herein as part of the same or separate embodiments, however, it will be appreciated that the scope of the claims and disclosure may include embodiments having combinations of all or some of the features described. It may be understood that the embodiments shown have the same or similar components, apart from where they are described as being different.

In the claims, any reference signs placed between parentheses shall not be construed as limiting the claim. The word ‘comprising’ does not exclude the presence of other features or steps than those listed in a claim. Furthermore, the words ‘a’ and ‘an’ shall not be construed as limited to ‘only one’, but instead are used to mean ‘at least one’, and do not exclude a plurality. The mere fact that certain measures are recited in mutually different claims does not indicate that a combination of these measures cannot be used to an advantage. Many variants will be apparent to the person skilled in the art as long as they are comprised within the scope of the invention defined in the following claims.

1: A support structure for a crane, the support structure comprising:
a lower end having a circular shape for connection with a slewing bearing;
an upper end having a polygonal shape for supporting a boom of the crane and/or a support frame of the crane;
an outer side connecting an outer edge of the upper end with an outer edge of the lower end;
wherein the upper end is provided with a pair of boom hinge connections for hingedly connecting the boom of the crane, and at least with a support frame connection for supporting the support frame of the crane;
wherein the outer side at least partly comprises plate parts forming a wall section for transition from the polygonal shape of the upper end to the circular shape of the lower end, wherein the plate parts comprise flat plate parts and curved plate parts.

2: The support structure according to claim 1, wherein below each one of the boom hinge connections and/or the support frame connections a box structure is provided to enable load transmission from the associated connection to the outer side and/or the lower end.

3: The support structure according to claim 2, wherein at least the box structures of a pair of boom hinge connections are joined to each other forming a joined box structure and/or of a pair of support frame connections are joined to each other forming a joined box structure.

4: The support structure according to claim wherein the box structures of a boom hinge connection and a support frame connection are joined to each other forming a joined box structure.

5: The support structure according to claim 3, wherein the joined box structure defines at least a part of the polygonal shape of the upper end of the support structure.

6: The support structure according to claim 3, wherein, when the box structures of the boom hinge connections and of the support frame connections are joined to each other, the said joined box structure provides for a polygonal box structure defining the polygonal shape of the upper end of the support structure.

7: The support structure according to claim 6, wherein the joined box structure forms an outer edge structure of the upper end.

8: The support structure according to claim 7, wherein the joined box structure forming the outer edge structure of the upper end is a circumferential outer edge structure having a central opening.

9: The support structure according to claim 2, wherein an upper side of the box structure provides a deck surface for mounting a boom hinge connection and/or a support frame connection thereto.

10: The support structure according to claim 2, wherein a box structure height of the box structure is larger at the boom hinge connections compared to at support frame connections spaced apart from the boom hinge connections.

11: The support structure according to claim 1, wherein the entire outer side is closed with plate parts forming a wall connecting the circular shaped lower end and the polygonal shaped upper end.

12: The support structure according to claim 1, wherein at least one boom hinge connection and/or at least one support frame connection is provided on a corner of the polygonal shape.

13: The support structure according to claim 1, wherein an inside of the outer side is provided with at least one circumferential ring structure.

14: The support structure according to claim 1, wherein an inside of the outer side is provided with a plurality of stiffeners extending in an upward direction.

15: The support structure according to claim 13, wherein the ring structure is provided with openings to allow a stiffener to pass through.

16: The support structure according to claim 1, wherein the polygonal shape of the upper end is hexagonal, septagonal or octagonal.

17: The support structure according to claim 1, wherein the upper end has a central opening for receiving further objects.

18: The support structure according to claim 1, wherein the pair of boom hinge connections and the at least one pair of support frame hinge connections are directly mounted to a deck surface of the upper end.

19: The support structure according to claim 1, wherein the polygonal shape has rounded-off corners at at least some of its vertices where boom hinge connections and/or support frame connections are arranged.

20: The support structure according to claim 1, wherein flat plate parts and curved plate parts are arranged adjacent to each other.

21: The support structure according to claim 20, wherein a flat plate part and an adjacent curved plate part alternate with each other when seen in a circumferential direction.

22: A crane comprising a base structure for mounting to a vessel or a barge or a jack-up, and the support structure according to claim 1, with a slewing bearing between the base structure and the support structure.

23: A vessel or barge or jack-up provided with the crane according to claim 22.
